(19) United States
(12) Patent Application Publication
(10) Pub. No.: US 2022/0339478 A1
(43) Pub. Date: Oct. 27, 2022

(54) Aerial Firefighting Systems and Methods With Positive Displacement Liquid Sensing to Control Valve Position

(71) Applicant: Victor D. Trotter, Fort Worth, TX (US)

(72) Inventor: Victor D. Trotter, Fort Worth, TX (US)

(21) Appl. No.: 17/239,636

(22) Filed: Apr. 25, 2021

(51) Int. Cl. A62C 3/02; B64D 1/16

(52) U.S. Cl. CPC A62C 3/0235; B64D 1/16

(57) ABSTRACT

Aerial firefighting systems and methods involve suspending a water-filled sack from an aircraft (e.g., a helicopter or an airplane) and controllably releasing the water out through a valve at the bottom of the sack to quench a target area over which the aircraft is flying. The valve is open and closed by an hydraulic valve actuator (e.g., an hydraulic cylinder), which is attached to the valve. A controller determines how far the valve is opened by monitoring how much of a finite amount of hydraulic fluid is conveyed to or from the hydraulic valve actuator. The finite amount of hydraulic fluid is determined by the action of a positive displacement apparatus in the aircraft. Some examples of a positive displacement apparatus include a gear pump, an hydraulic cylinder, and a plunger pump. The systems and methods avoid the need for installing an electric valve position sensor in the sack.

### FIELD OF THE DISCLOSURE

This patent generally pertains to aerial firefighting systems and methods and more specifically to systems and methods for controlling a valve that releases fire quenching water from a sack or other liquid reservoir hanging from an aircraft.

### BACKGROUND

Some aircraft (e.g., airplanes and helicopters) are used for aerial firefighting, which may involve extinguishing, containing or otherwise fighting a fire. In some examples, a large flexible sack, such as a bag or bellows, is hung from the underside of the aircraft. The sack is usually filled with water drawn from a lake or other body of water. To quench a target area over which the aircraft is flying, a valve at the bottom of the sack is opened to dump some or all of the water onto the target area. The process can be repeated till the job is done.

### BRIEF DESCRIPTION OF THE DRAWINGS

FIG. 1 is a schematic side view of an example aerial firefighting system constructed in accordance with the teachings disclosed herein.

FIG. 2 is a schematic side view of the aerial firefighting system shown in FIG. 1 but showing the system releasing a liquid.

FIG. 3 is a diagram showing the aerial firefighting system 4 performing an example mission in accordance with the teachings disclosed herein.

FIG. 4 is a schematic side view of an example sack, valve and hydraulic valve actuator constructed in accordance with the teachings disclosed herein.

FIG. 5 is a schematic side view similar to FIG. 4 but showing the valve slightly open.

FIG. 6 is a schematic side view similar to FIG. 5 but showing the valve open further.

FIG. 7 is a schematic side view similar to FIG. 6 but showing the valve fully open.

FIG. 8 is a schematic diagram showing an example positive displacement apparatus, valve and hydraulic valve actuator that can be used with a pair of hydraulic lines for the example aerial firefighting system shown in FIGS. 1-3.

FIG. 9 is a schematic diagram showing an example positive displacement apparatus, valve and hydraulic valve actuator that can be used with a single hydraulic line for the example aerial firefighting system shown in FIGS. 1-3.

FIG. 10 is a schematic diagram showing another example positive displacement apparatus, valve and hydraulic valve actuator that can be used with a single hydraulic line for the example aerial firefighting system shown in FIGS. 1-3.

FIG. 11 is a schematic diagram showing yet another example positive displacement apparatus, valve and hydraulic valve actuator that can be used with a single hydraulic line for the example aerial firefighting system shown in FIGS. 1-3.

FIG. 12 is a schematic diagram showing another example positive displacement apparatus, valve and hydraulic valve actuator that can be used with a pair of hydraulic lines for the example aerial firefighting system shown in FIGS. 1-3.

FIG. 13 is a schematic side view of another example aerial firefighting system constructed in accordance with the teachings disclosed herein.

FIG. 14 is a schematic side view of the aerial firefighting system shown in FIG. 13 but showing the system's diaphragm-style sack deployed and releasing a liquid.

### DETAILED DESCRIPTION

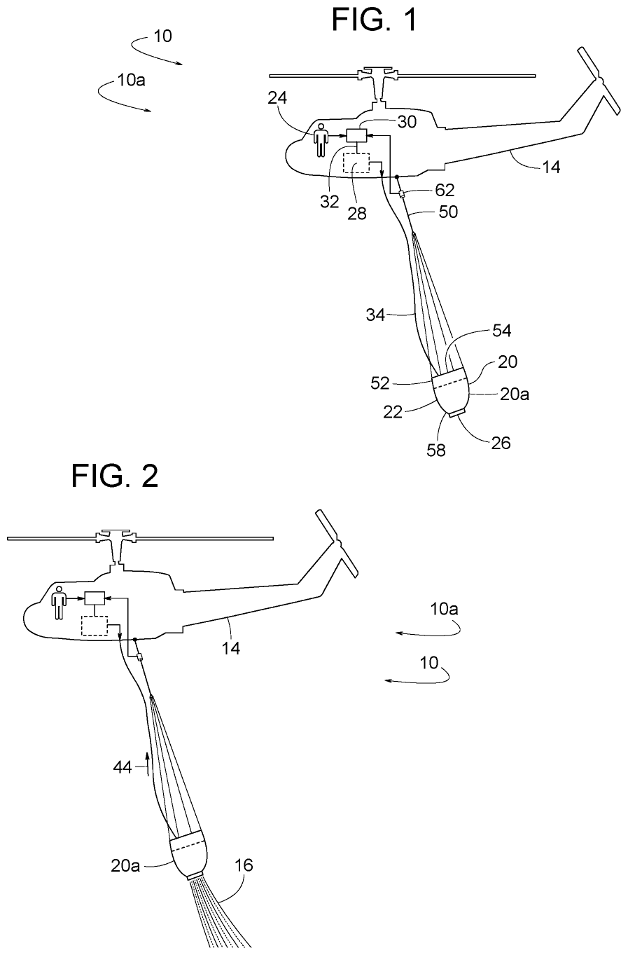

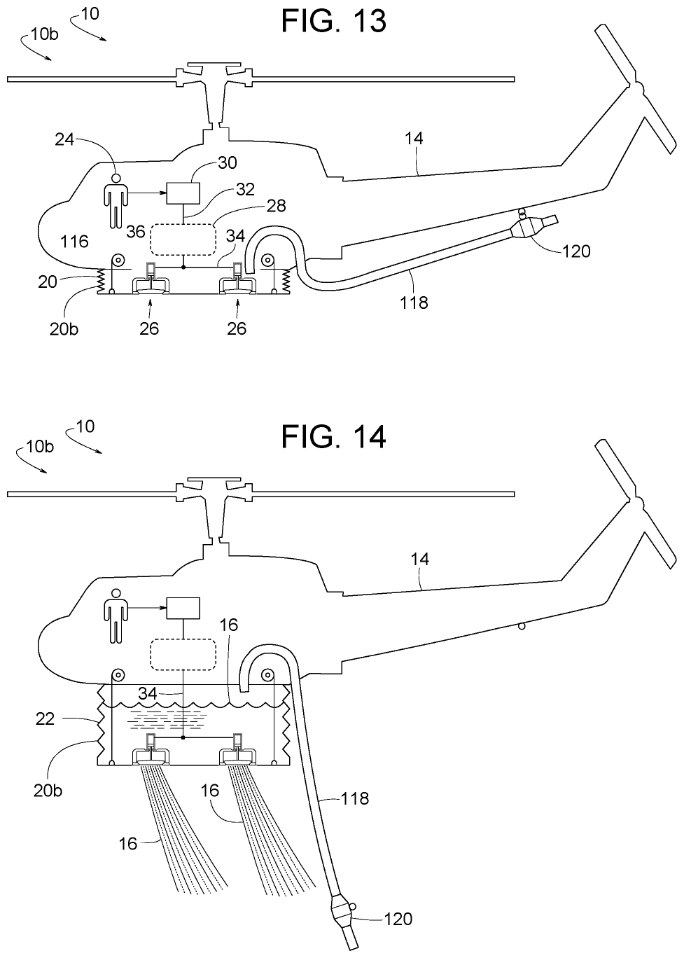

FIGS. 1-14 pertain to example aerial firefighting methods and systems 10 (e.g., aerial firefighting system 10a of FIGS. 1-12 and aerial firefighting system 10b of FIGS. 13 and 14) for extinguishing, containing, or otherwise fighting a fire 12. The methods and systems involve using an aircraft 14 (e.g., a helicopter or airplane) to controllably release a liquid 16 (e.g., water, fire retardant, and combinations thereof) onto one or more target areas 18 underneath aircraft 14. The term, “aircraft” refers to any flying machine.

To quench a target area 18, liquid 16 is released from a resiliently collapsible sack 20 (e.g., sack 20a of FIGS. 1-12 and sack 20b of FIGS. 13 and 14) hanging from aircraft 14. The term, “resiliently collapsible sack” refers to a vessel with deformable side walls that are sufficiently flexible to allow the vessel to be compressed and later expanded to its uncompressed shape without appreciable permanent deformation to the side walls.

Sack 20 being resiliently collapsible provides a suspended bag version of sack 20 (e.g., sack 20a) with sufficient durability to tolerate being knocked around against the ground and sufficient collapsibility for subsequent storage and handling. Sack 20 being resiliently collapsible provides a bellows style version of sack 20 (e.g., sack 20b of FIGS. 13 and 14) with sufficiently flexibility to collapse compactly underneath aircraft 14 when not in use, as shown in FIG. 13 and later expanded when deployed, as shown in FIG. 14.

Some examples of resiliently compressible sack 20 include a bag, a flexible scoop, a flexible bucket, a bellows, and a pouch. FIGS. 1-12 show resiliently flexible sack 20a in the form of a bag or pouch. FIGS. 13 and 14 show resiliently flexible sack 20b in the form of a bellows. Example side wall materials 22 of resiliently flexible sack 20 include plastic, rubber, fabric, canvas, and combinations thereof. Plastic and rubber are example polymeric materials.

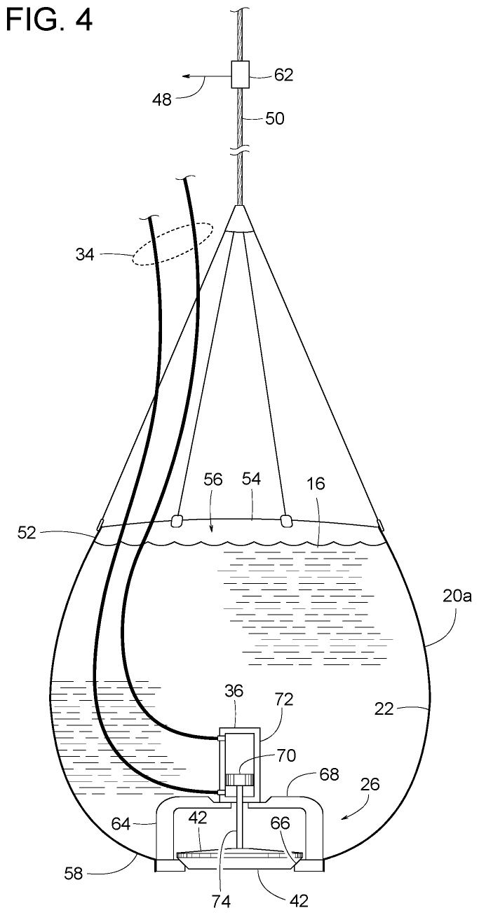

Some examples of aerial firefighting system 10 carried by aircraft 14 and operated by a user 24 (e.g., a pilot or crew member on aircraft 14) include resiliently collapsible sack 20 hanging from aircraft 14, a valve 26 to controllably release liquid 16 out from the bottom of sack 20, a positive displacement apparatus 28 on aircraft 14 to determine the open/closed position of valve 26, a controller 30 connected in signal communication (via a communication link 32) with positive displacement apparatus 28, and at least one hydraulic line 34 extending from positive displacement apparatus 28 to an hydraulic valve actuator 36 (e.g., FIG. 4) of valve 26.

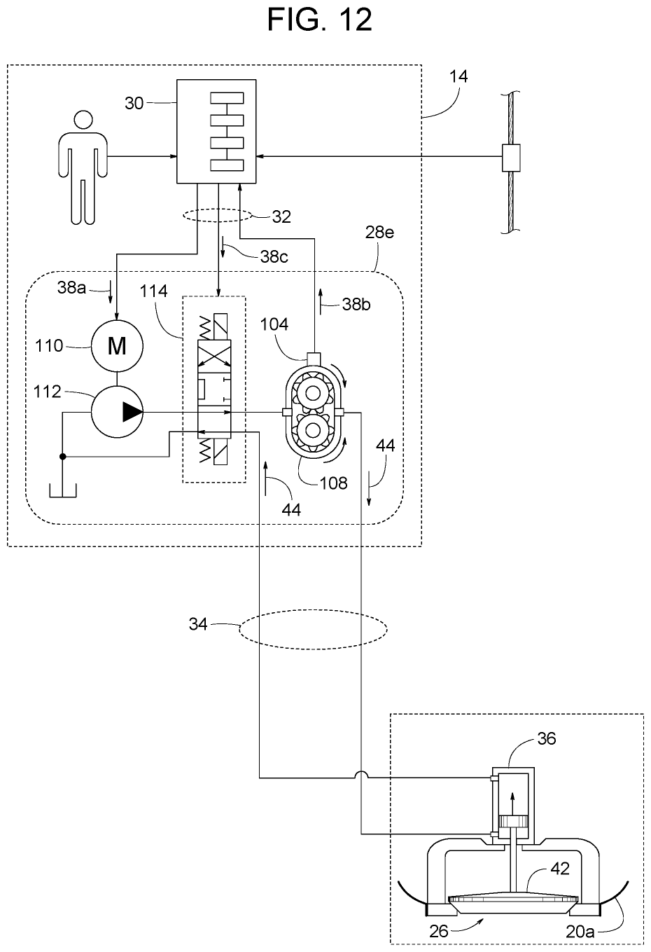

Communication link 32 conveys at least one communication signal 38 between controller 30 and positive displacement apparatus 28. One example of communication signal 38 includes a drive signal 38a from controller 30 to positive displacement apparatus 28. Another example of communication signal 38 includes a feedback signal 38b from positive displacement apparatus 28 to controller 30. A valve control signal 38c (FIG. 12) is another example of communication signal 38.

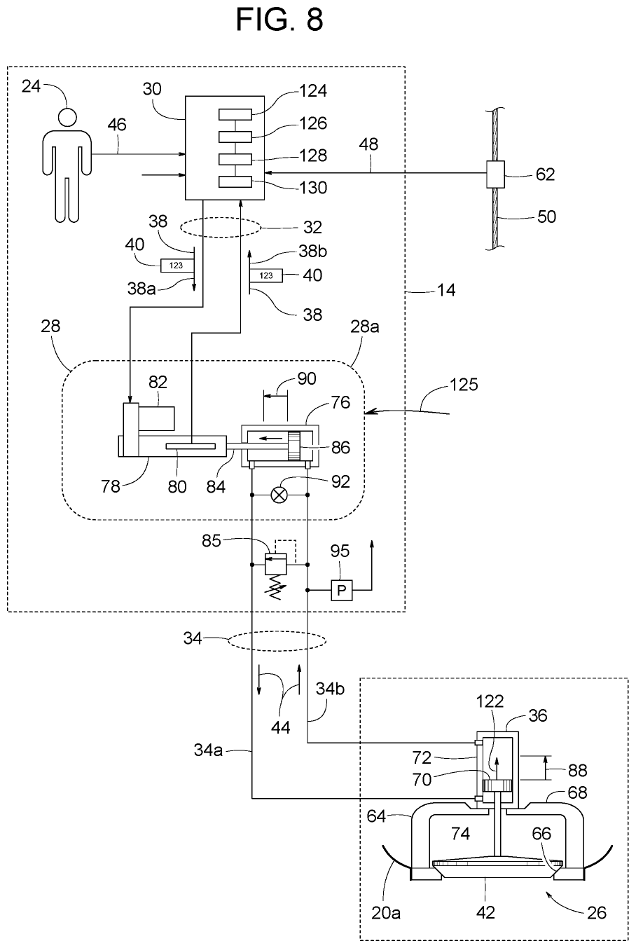

In some examples, as shown in FIG. 8, feedback signal 38b provides controller 30 with a valve position value 40 (e.g., 0-10 volts, 4-20 mA, an encoder count value, etc.) indicating that movable valve member 42 is at some desired valve position. In some examples, drive signal 38a from controller 30 provides valve position value 40 indicating that movable valve member 42 is being driven to or is already at some desired valve position.

The term, “positive displacement apparatus” refers to any device or machine having at least one chamber that moves (linearly and/or rotationally) while at a substantially fixed volume to convey, via the moving chamber, a corresponding substantially fixed volume of an hydraulic fluid. The term, “hydraulic fluid” refers to any generally incompressible liquid (e.g., oil, water, water/glycol mixture, biodegradable oil, vegetable oil, etc.). In some examples, the device or machine is externally driven (e.g., via a motor, a linear actuator, etc.) to forcefully move the chamber and liquid the chamber contains.

Conversely, in some examples, the incompressible liquid in the chamber provides a driving force that moves the chamber (e.g., a positive displacement flow meter). Some examples of positive displacement apparatus 28 include a gear pump, a piston pump, a plunger pump, an axial displacement swash plate piston pump, a diaphragm pump, a lobe pump, a vane pump, a peristaltic pump, a screw pump, and a progressive cavity pump. Some examples of positive displacement apparatus 28 include the list of pumps just mentioned but operated such that the incompressible liquid drives the positive displacement apparatus rather than vice versa.

Positive displacement apparatus 28 is relied upon for determining how far valve 26 is open based on how much of a finite amount of hydraulic fluid 44 has passed through hydraulic line 34 between positive displacement apparatus 28 and hydraulic valve actuator 36. Positive displacement apparatus 28 on aircraft 14 enables controller 30 to determine the position of valve 26 without the need for a valve position sensor at valve 26. This allows controller 30 and positive displacement apparatus 28 to be in electrical signal isolation from hydraulic valve actuator 36 and valve 26, thus avoiding the cost and difficulty of contending with wiring and electrical components in an area that is remote from aircraft 14 and subject to possible liquid contamination, jostling, and harsh environmental conditions. Consequently, in some examples, there are no electronic components in the resiliently compressible sack 20. Instead, valve position is determined from positive displacement apparatus 28, which is inside aircraft 14. Any electronics associated with positive displacement apparatus 28 are in a protected environment and thus less likely to be damaged.

Controller 30 is schematically illustrated to represent any type of electrical device or collection of interconnected devices for providing at least one output signal (e.g., drive signal 30a) in response to receiving at least one user input signal 46, a load signal 48, feedback signal 30b and/or valve control signal 30c. Some examples of controller 30 and/or parts thereof include a computer, a microprocessor, an integrated circuit, a programmable logic controller, an off-the-shelf industrial controller, a Color Message Interface, a DataVault system, an FRDS (Gen III fire response dispersal system) plus associated electrical components thereof and various combinations thereof. Controller 30 can be mounted anywhere, e.g., on the exterior of aircraft 14, inside aircraft 14, or hung outside of aircraft 14. In some examples, controller 4 is suspended from aircraft 14 near load cell 62. The Color Message Interface, DataVault system, and FRDS are products provided by Trotter Controls of Ft. Worth, Tex. In some examples, controller 30 uses a Color Message Interface to advise user 24 (e.g., the pilot) as to the maximum permissible forward aircraft speed for achieving a desired liquid coverage level, which user 24 enters into controller 30.

In the example shown in FIGS. 1-7, resiliently collapsible sack 20a is in the form of a bag or pouch suspended from aircraft 14 by a suspension line 50 (e.g., one or more cables, a harness, straps, etc.). In some examples, multiple sacks 20a (e.g., two or three) are suspended from a single aircraft 14. Suspension line 50 connects to an upper end 52 of sack 20a along a brim 54 that defines an opening 56 through which liquid 16 enters to fill sack 20a. Valve 26 is at a lower end 58 of sack 20. FIG. 1 shows valve 26 closed. FIG. 2 shows valve 26 open to release a downpour of liquid 16 out from the bottom of sack 20.

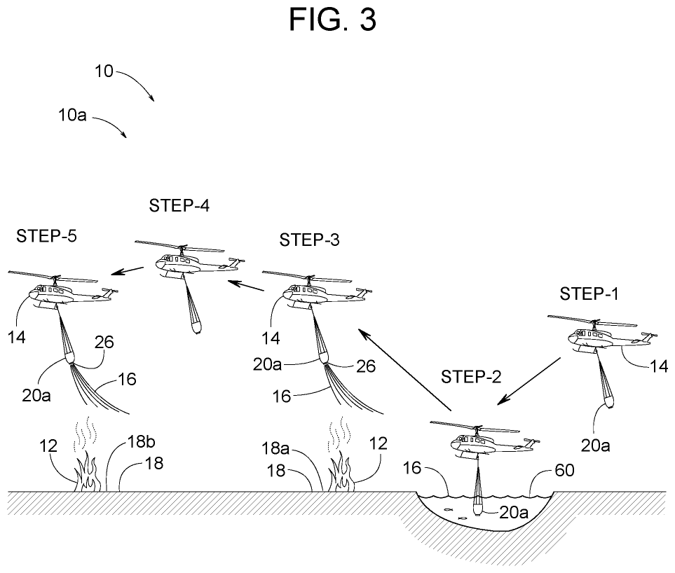

FIG. 3 shows a five-step sequence of an example mission carried out by aerial firefighting system 10a. In Step-1, going from right to left in FIG. 3, aircraft 14 carries empty sack 20a to be filled at a water source 60 (e.g., tank, lake, pond, reservoir, river, stream, swimming pool, etc.). Step-2 shows sack 20a being filled with liquid 16 upon being submerged in water source 60. Step-3 shows aircraft 14 having carried a liquid-filled sack 20a over to a first target 18a. Valve 26 opens to release a first portion of liquid 16 onto first target 18a. Step-4 shows aircraft 14 carrying sack 20a, partially filled with liquid, 16 to a second target 18b. To conserve liquid 16, valve 26 is closed while aircraft′ 14 flies from first target 18a to second target 18b. Step-5 shows valve 26 reopened to release a second portion of liquid 16 onto second target 18b.

In some examples, to provide a substantially uniform liquid flow rate through valve 26, positive displacement apparatus 28 adjusts the opening of valve 26 to decrease the valve's flow resistance as the liquid level in sack 20 decreases. For instance, in some examples, valve 26 is at a restricted open position at first target 18a when sack 20a is relatively full, and valve 26 is more open at second target 18b when the liquid level in sack 20a is relatively low.

FIGS. 4-7 illustrate the concept of progressively opening valve 26 to progressively decrease the valve's flow resistance based at least partially on how much liquid 16 is in resiliently collapsible sack 20. To determine how much liquid 16 is in sack 20, some examples of system 10 include a known load cell 62 operatively coupled to suspension line 50. Load cell 62, sometimes known as a hook load indicator, provides load signal 48 that varies based on the weight of liquid 16 in resiliently collapsible sack 20.

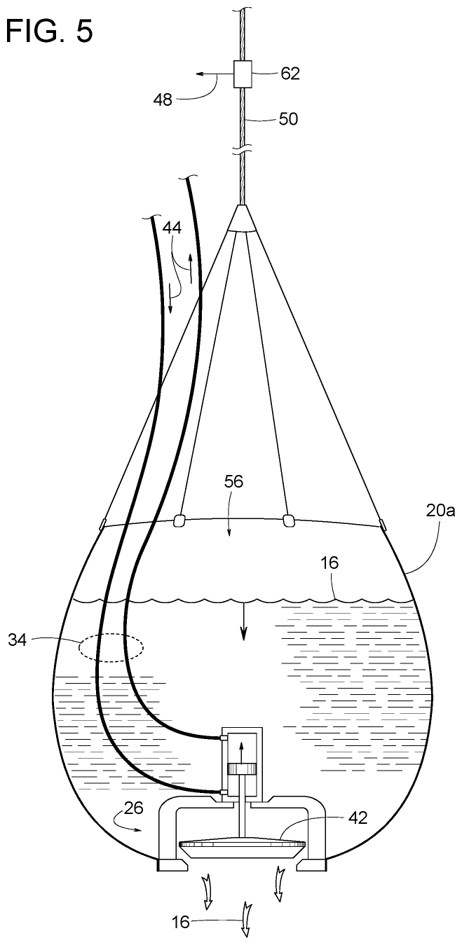

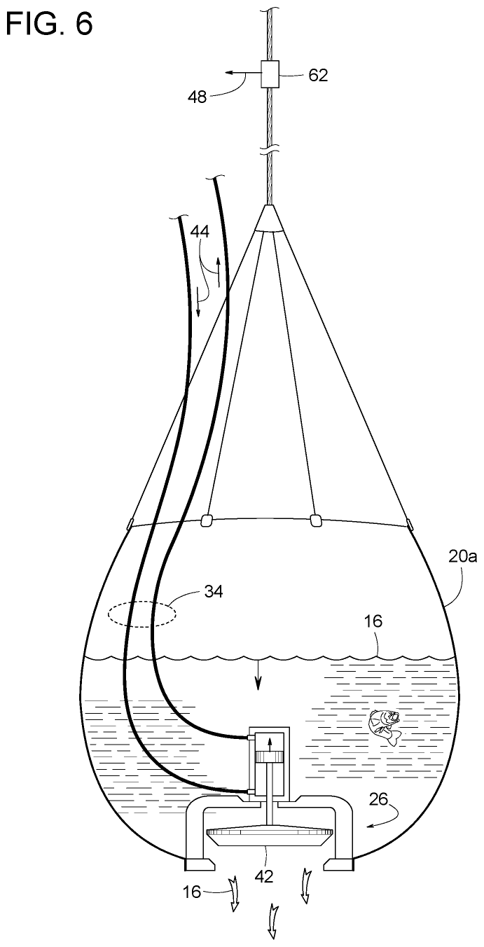

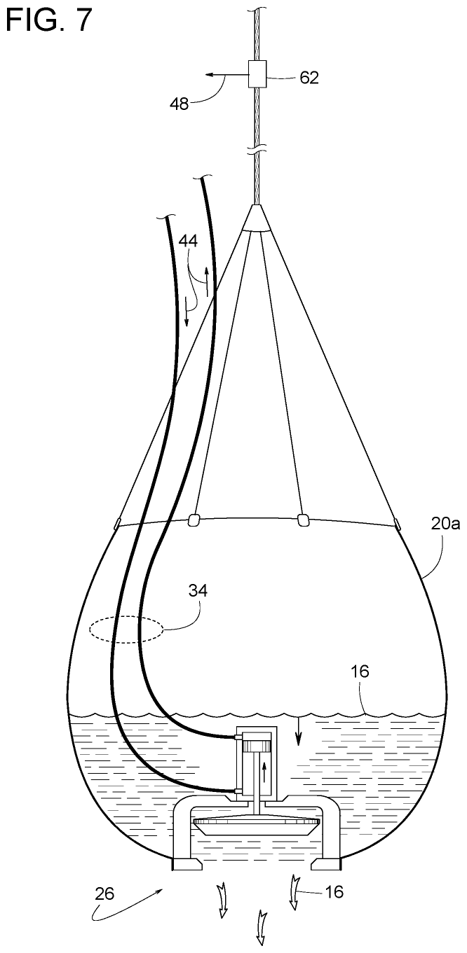

FIG. 4 shows valve 26 fully closed. FIG. 5 shows valve 26 slightly open when the level of liquid 16 is relatively high, as sensed by load cell 62. FIG. 6 shows valve 26 open further in response to load signal 48 indicating that the level of liquid 16 has decreased from the level shown in FIG. 5 to that shown in FIG. 6. FIG. 7 shows valve 26 open even further in response load signal 48 indicating that the level of liquid 16 has decreased from the level shown in FIG. 6 to that shown in FIG. 7. So, in other words, the open/close position of valve 26 is modulated to achieve a constant or otherwise desired flow performance.

In some examples, valve 26 and hydraulic valve actuator 36 are constructed as shown in FIGS. 4-7. Some examples of valve 26 include a valve frame 64 attached to the sack's lower end 58. Valve frame 64 includes an annular valve seat 66. Valve 26 also includes movable valve member 42 that is movable relative to valve seat 66 to various desired valve positions of a plurality of valve positions. The plurality of valve positions covers a range extending from a fully closed position (FIG. 4) and a fully open position (FIG. 7). Liquid 16 is able to drain past valve seat 66 when movable valve member 42 is at least partially open (e.g., FIGS. 5-7) or deviates from the fully closed position (FIG. 4).

In some examples, valve frame 64 includes at least one arm 68 for supporting hydraulic valve actuator 36. In the illustrated example, hydraulic valve actuator 36 includes a piston 70 that slides axially along an hydraulic cylinder 72. A piston rod 74 connects piston 70 to movable valve member 42 such that piston 70, piston rod 74 and movable valve member 42 move as a unit.

To control the operation of hydraulic valve actuator 36 and thus control the opening of valve 26, some examples of positive displacement apparatus 28, e.g., positive displacement apparatuses 28a, 28b, 28c, 28d, and 28e are constructed as shown in FIGS. 8-12, respectively. Positive displacement apparatus 28a of FIG. 8 includes an hydraulic cylinder 76 driven by an electric linear actuator 78.

Some examples of linear actuator 78 include a threaded nut and leadscrew, a rack and pinion, etc. Some examples of linear actuator 78 are provided by Thomson of Radford, Va., USA. In some examples, additional components are added to linear actuator 78. Examples of such additional components include clevis mounting hardware, a rod extension, a rod coupling, an integral brake, one or more position sensors 80, etc. Some example position sensors 80 are provided by Turck of Mulheim an der Ruhr, Germany.

In some examples, in response to input signal 46 from user 24, controller 30 provides drive signal 38a to a motor 82 of linear actuator 78. Drive signal 38a commands linear actuator 78 to selectively extend or retract a piston rod 84 that is connected to a piston 86 that slides within hydraulic cylinder 76. The movement of piston 86 displaces a finite amount of hydraulic fluid 44, which passes through one or more hydraulic lines 34 (e.g., a supply line 34a and a return line 34b) between positive displacement apparatus 28 and hydraulic valve actuator 36.

The finite amount of hydraulic fluid 44 flowing through hydraulic line 34 forces hydraulic valve actuator 36 to move the movable valve member 42 a finite distance 88 based on the finite amount of hydraulic fluid 44. The volume of the finite amount of hydraulic fluid 44 is at least partially determined by the volumetric displacement characteristics of positive displacement apparatus 28 and a distance 90 over which the electric linear actuator 78 moves piston 86.

Distance 90 can be determined by various means. In some examples, electric linear actuator 78 and/or cylinder 76 includes a magnetic position sensor 80 for measuring distance 90. In some examples, sensor 80 provides feedback signal 38b to indicate the distance 90 and thus the position of movable valve member 42. In some examples, positive displacement apparatus 28 includes a bypass bleed valve 92 for purging air and/or for zeroing feedback signal 38b when movable valve member 42 is at its fully closed position (FIG. 8).

In addition or as an alternative to bypass bleed valve 92, some examples of purging the air from hydraulic line 34b include a pressure relief valve 85 across lines 34 and a pressure sensor 95 on line 34b. This will only be used during initial set up of the system and not during ongoing normal operation.

At the first power-on cycle, hydraulic cylinder 76 forces hydraulic fluid through line 34b to force valve 26 to its fully closed position. Upon valve member 42 reaching its end-of-travel, as indicated by a significant increase in hydraulic pressure in line 34b as measured by pressure sensor 95, cylinder 76 continues pressurizing line 34b till pressure relief valve 85 opens.

Pressure relief valve 85, when open, allows hydraulic fluid and entrapped air to bleed out of cylinder 72, through line 34b, and into line 34a; thereby purging the system. Purging the entrapped air, during initial startup, ensures that valve 26 will truly be closed whenever it is driven closed during normal operation.

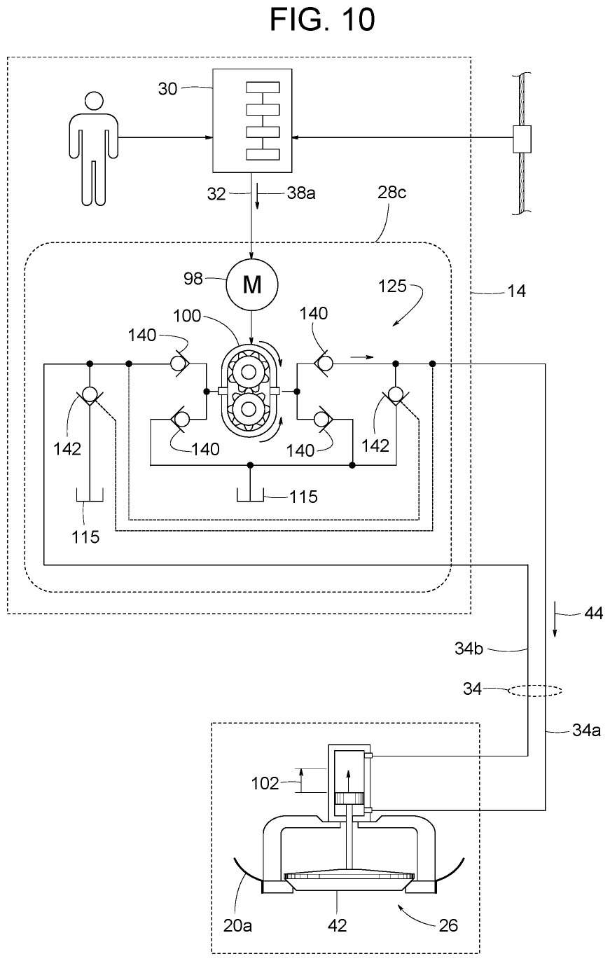

Bypass bleed valve 92, pressure relief valve 85, and/or pressure sensor 95 can be used for purging other example hydraulic system disclosed herein. Such means for purging, however, is particularly useful for hydraulic circuits that can bleed the purged air to a return hydraulic fluid tank 115, as shown in FIG. 10, for example.

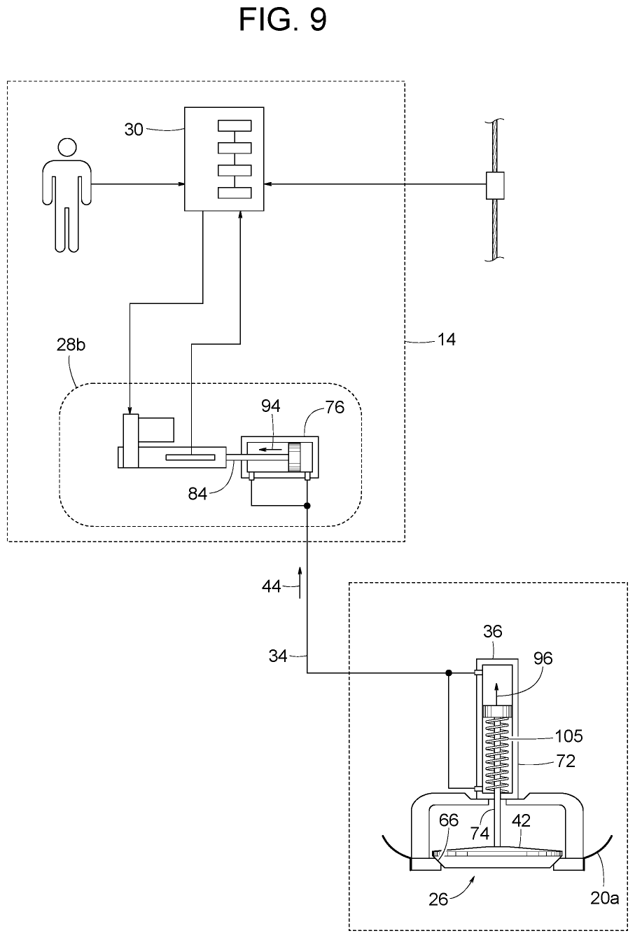

Positive displacement apparatus 28b of FIG. 9 is similar to positive displacement 28a of FIG. 8. With positive displacement apparatus 28b, however, only one hydraulic line 34 extends between positive displacement apparatus 28b and hydraulic valve actuator 36. In this example, each of cylinders 72 and 76 function much like a ram pump where volumetric displacement of hydraulic fluid 44 is determined based on the volume of piston rods 74 and 84 entering or leaving the interior of their respective cylinders 72 and 76. As piston rod 84 of positive displacement apparatus 28b withdraws from within hydraulic cylinder 76, as indicated by arrow 94, piston rod 74 of hydraulic valve actuator 36 and compression spring 105 forces movable valve member 42 up and away from valve seat 66, as indicated by arrow 96.

In the example shown in FIG. 10, positive displacement apparatus 28c includes a motor 98 driving the rotation of a gear pump 100. To open valve 26 a certain amount, controller 30 outputs drive signal 38a to rotate gear motor 100 a certain amount. Under the command of drive signal 38a, gear motor 100 forces a finite amount of hydraulic fluid 44 through hydraulic line 34, which moves movable valve member 42 up a corresponding finite distance 102. In some open loop control examples, as shown in FIG. 10, controller 30 inherently knows the value of the finite amount of hydraulic fluid 44 based on the value of drive signal 38a outputted by controller 30.

In the example shown in FIG. 10, positive displacement apparatus 28c further includes an hydraulic circuit 125 with four conventional check valves 140 and two pilot operated check valves 142. Valves 140 and 142, in the arrangement shown in FIG. 10, enables gear pump 100 to force valve member 42 in either direction, open or closed, without additional control circuitry such as directional solenoid valves. The valve arrangement shown in FIG. 10 can be used in other actuator systems including, integrated electro-hydraulic linear actuators, other linear actuators, the actuator system shown in FIG. 8, rotary actuators, etc.

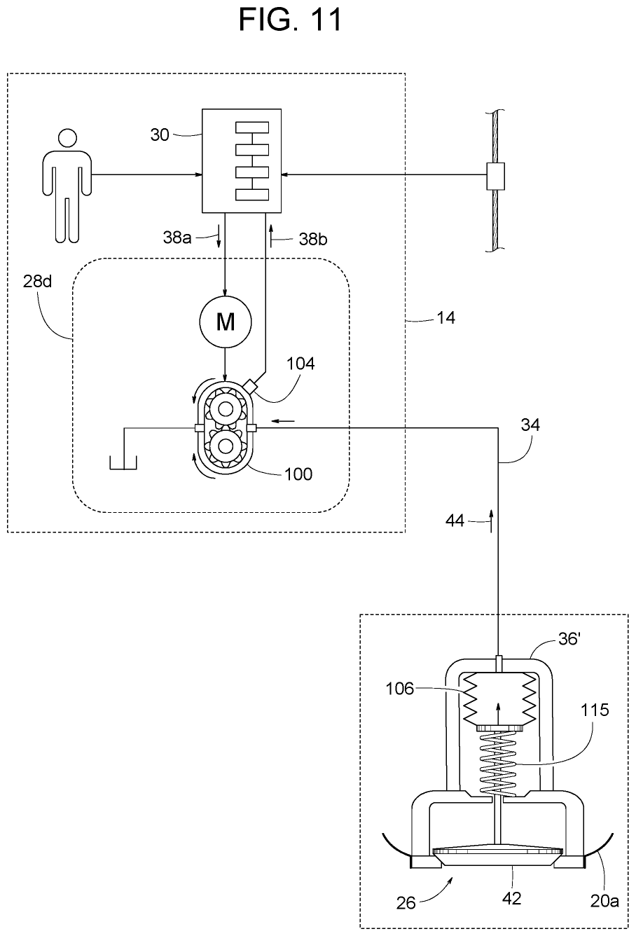

In some closed loop examples, such as positive displacement apparatus 28d shown in FIG. 11, controller 30 acquires the value of the finite amount of hydraulic fluid 44 based on feedback signal 38b from an encoder 104 measuring the rotation of gear pump 100. FIG. 11 also shows an alternative hydraulic valve actuator 36′ in the form of a diaphragm 106. Diaphragm 106 is hermetically sealed, so it needs no sliding seals for containing hydraulic fluid 44. A compression spring 115 or a cylinder with an internal spring is used for urging valve member 42 to its raised open position. In some examples (e.g., FIGS. 8 and 9), hydraulic valve actuator 36′ can be used instead of valve actuator 36.

In the example shown in FIG. 12, positive displacement apparatus 28e uses a gear pump 108 as a positive displacement flow meter. In this example, gear pump 108 is driven by hydraulic fluid 44 being forced through it, rather than being driven directly by a motor.

In the illustrated example, controller 30 provides drive signal 38a to control a motor 110 that powers a conventional hydraulic pump 112. Controller 30 also provides a valve control signal 38c to a directional valve 114 that determines whether hydraulic fluid 44 forces valve 26 open, forces valve 26 closed, or forces valve 26 to remain at a chosen open/closed position. In this example, gear pump 108 (operating as a positive displacement flow meter) provides controller 30 with feedback signal 38b that indicates the volume of the finite amount of hydraulic fluid 44 flowing to or from hydraulic valve actuator 36, and thus indicates the position of movable valve member 42.

In the examples shown in FIGS. 13 and 14, resiliently collapsible sack 20b, in the form of a bellows, can employ one or more of the same example valve 20b, positive displacement apparatus 28, and controller 30 as used with sack 20a of FIGS. 1-12. In the illustrated example, aerial firefighting system 10b also includes retractable means 116 (e.g., springs, hoists, cables, and combinations thereof, etc.) for retracting and collapsing sack 20b in a compact shape when not in use. In some examples, the weight of liquid 16 provides the downward force to deploy sack 20b. In some examples, a hose 118 with a pump 120 is used for drawing liquid 16 up from water source 60 and into sack 20b. When not in use, hose 118 can be secured and stowed in a generally horizontal configuration, as shown in FIG. 13. Valves 26 are closed in FIG. 13 and are open to release liquid 16 in FIG. 14.

It should be noted that arrow 125 of FIG. 8 illustrates installing positive displacement apparatus 28 on aircraft 14 such that positive displacement apparatus 28 is higher and spaced apart from hydraulic valve actuator 36. Arrow 122 of FIG. 8 illustrates opening valve 26 a certain amount by sending drive signal 38a to cause positive displacement apparatus 28 to force a finite volume of hydraulic fluid 44 between positive displacement apparatus 28 and hydraulic valve actuator 36. FIG. 8 shows controller 30 implementing a plurality of methods blocks 124, 126, 128, and 130. Block 124 represents determining the finite volume of hydraulic fluid 44 based at least partially on a known volumetric displacement characteristic (e.g., volume of cylinder 76 displaced by piston 86) of positive displacement apparatus 28. Block 126 represents inferring how far valve 26 is open based at least partially on the finite volume of hydraulic fluid 44. Block 128 represents determining (e.g., via load signal 48) how much of liquid 16 is in the resiliently collapsible sack 20. Block 130 represents progressively opening valve 26 (compare FIGS. 5, 6 and 7) to progressively decrease a flow resistance of valve 26 based at least partially on how much of liquid 16 is in the resiliently collapsible sack 20. FIGS. 8-12 show examples of maintaining positive displacement apparatus 28 and hydraulic valve actuator 36 in electric signal isolation from each other (i.e., no electrical lines run from positive displacement apparatus 28 to anything hanging in suspension below suspension line 50 or anything that might be supported by valve frame 64).

Some examples of aerial firefighting system 10 and its associated methods can be defined as follows:

Example-1 An aerial firefighting method for using an aircraft to controllably release a liquid from a resiliently collapsible sack hanging from the aircraft, wherein the resiliently collapsible sack includes a valve that is operated by an hydraulic valve actuator, the aerial firefighting method, comprising: installing a positive displacement apparatus on the aircraft such that the positive displacement apparatus is higher and spaced apart from the hydraulic valve actuator; opening the valve a certain amount by sending a drive signal that causes the positive displacement apparatus to force a finite volume of an hydraulic fluid between the positive displacement apparatus and the hydraulic valve actuator; determining the finite volume based at least partially on a known volumetric displacement characteristic of the positive displacement apparatus; and inferring how far the valve is open based at least partially on the finite volume.

Example-2 The aerial firefighting method of Example-1, further comprising: determining how much of the liquid is in the resiliently collapsible sack; and progressively opening the valve to progressively decrease a flow resistance of the valve based at least partially on how much of the liquid is in the resiliently collapsible sack.

Example-3 The aerial firefighting method of Example 1, further comprising maintaining the positive displacement apparatus and the hydraulic valve actuator in electric signal isolation from each other.

Example-4 The aerial firefighting method of Example-1, wherein the positive displacement apparatus includes a gear pump.

Example-5 The aerial firefighting method of Example-1, wherein the positive displacement apparatus includes an hydraulic cylinder.

Example-6 The aerial firefighting method of Example-1, wherein the positive displacement apparatus includes an electric linear actuator coupled to an hydraulic cylinder.

Example-7 The aerial firefighting method of Example-1, wherein the positive displacement apparatus includes a positive displacement flow meter.

Example-8 The aerial firefighting method of Example-1, wherein the resiliently collapsible sack is a bag hanging by a suspension line from the aircraft.

Example-9 An aerial firefighting system for an aircraft used by a user to controllably release a liquid onto an area over which the aircraft is flying, the aerial firefighting system, comprising: a resiliently collapsible sack for carrying the liquid while the resiliently collapsible sack is hanging underneath the aircraft; a valve frame attached to a lower end of the resiliently collapsible sack, the valve frame having a valve seat; a movable valve member being movable relative to the valve seat to a desired valve position of a plurality of valve positions, wherein the plurality of valve positions covers a range extending from a fully closed position and a fully open position, the liquid being able to drain past the valve seat when the movable valve member deviates from the fully closed position; an hydraulic valve actuator to move the movable valve member to the plurality of valve positions, the hydraulic valve actuator being supported by the valve frame; a positive displacement apparatus attached to the aircraft and being spaced apart and elevated above the hydraulic valve actuator; an hydraulic line connecting the positive displacement apparatus in fluid communication with the hydraulic valve actuator; a finite amount of hydraulic fluid passing through the hydraulic line to force the hydraulic valve actuator to move the movable valve member a finite distance based on the finite amount of hydraulic fluid, the finite amount of hydraulic fluid being at least partially determined by the positive displacement apparatus; a controller connected in signal communication with the positive displacement apparatus, the controller providing a drive signal to the positive displacement apparatus in response to receiving an input signal from the user, the drive signal commanding the positive displacement apparatus to move the finite amount of hydraulic fluid through the hydraulic line so as to force the hydraulic valve actuator to move the movable valve member the finite distance; a communication signal transmitted between the controller and the positive displacement apparatus, the communication signal including at least one of the drive signal from the controller and a feedback signal from the positive displacement apparatus; and a valve position value indicating that the movable valve member is at the desired valve position, the valve position value being provided by at least one of the feedback signal from the positive displacement apparatus to the controller and the drive signal from the controller to the positive displacement apparatus.

Example-10 The aerial firefighting system of Example-9, wherein the controller and the positive displacement apparatus are in electric signal isolation from the hydraulic valve actuator and everything else hanging in suspension below the suspension line.

Example-11 The aerial firefighting system of Example-9, wherein the positive displacement apparatus includes a gear pump.

Example-12 The aerial firefighting system of Example-9, wherein the positive displacement apparatus includes an hydraulic cylinder.

Example-13 The aerial firefighting system of Example-9, wherein the positive displacement apparatus includes an electric linear actuator coupled to an hydraulic cylinder.

Example-14 The aerial firefighting system of Example-9, wherein the positive displacement apparatus includes a positive displacement flow meter.

Example-15 The aerial firefighting system of Example-9, wherein the resiliently collapsible sack is a bag having a polymeric side wall with an upper brim defining an opening through which the liquid can enter the bag.

Example-16 The aerial firefighting system of Example-9, wherein the resiliently collapsible sack is a bellows having a polymeric side wall.

Example-17 The aerial firefighting system of Example-9, wherein the controller and the positive displacement apparatus are in electric signal isolation from the hydraulic valve actuator and anything else that might be supported the valve frame.

Example-18 The aerial firefighting system of Example-9, further comprising: a suspension line to suspend the resiliently collapsible sack, the hydraulic valve actuator, the valve frame, the valve seat, and the movable valve member from the aircraft, the suspension line being coupled to a brim of the resiliently collapsible sack; and a load cell operatively coupled to the suspension line to provide a load signal that varies based on the weight of the liquid in the resiliently collapsible sack.

Example-19 An aerial firefighting system for an aircraft used by a user to controllably release a liquid onto an area over which the aircraft is flying, the aerial firefighting system, comprising: a resiliently collapsible sack for carrying the liquid, the resiliently collapsible sack having an upper end and a lower end, the resiliently collapsible sack having a brim defining an opening at the upper end to receive the liquid; a valve frame attached to the lower end of the resiliently collapsible sack, the valve frame having a valve seat; a movable valve member being movable relative to the valve seat to a desired valve position of a plurality of valve positions, wherein the plurality of valve positions covers a range extending from a fully closed position and a fully open position, the liquid being able to drain past the valve seat when the movable valve member deviates from the fully closed position; an hydraulic valve actuator to move the movable valve member to the plurality of valve positions, the hydraulic valve actuator being supported by the valve frame; a suspension line to suspend the resiliently collapsible sack, the hydraulic valve actuator, the valve frame, the valve seat, and the movable valve member from the aircraft, the suspension line being coupled to the brim of the resiliently collapsible sack; a load cell operatively coupled to the suspension line to provide a load signal that varies based on the weight of the liquid in the resiliently collapsible sack; a positive displacement apparatus attached to the aircraft and being spaced apart and elevated above the resiliently collapsible sack when the resiliently collapsible sack is suspended from the aircraft by the suspension line; an hydraulic line connecting the positive displacement apparatus in fluid communication with the hydraulic valve actuator; a finite amount of hydraulic fluid passing through the hydraulic line to force the hydraulic valve actuator to move the movable valve member a finite distance based on the finite amount of hydraulic fluid, the finite amount of hydraulic fluid being at least partially determined by the positive displacement apparatus; a controller connected in signal communication with the positive displacement apparatus, the controller providing a drive signal to the positive displacement apparatus in response to receiving an input signal from the user and the load signal from the load cell, the drive signal commanding the positive displacement apparatus to move the finite amount of hydraulic fluid through the hydraulic line so as to force the hydraulic valve actuator to move the movable valve member the finite distance; a communication signal transmitted between the controller and the positive displacement apparatus, the communication signal including at least one of the drive signal from the controller and a feedback signal from the positive displacement apparatus; and a valve position value corresponding to the finite amount of hydraulic fluid, the valve position value being referenced by the controller to help determine whether the movable valve member is at the desired valve position, the valve position value being provided by at least one of the feedback signal from the positive displacement apparatus to the controller and the drive signal from the controller to the positive displacement apparatus.

Example-20 The aerial firefighting system of Example-19 wherein the controller and the positive displacement apparatus are in electric signal isolation from the hydraulic valve actuator and everything else hanging in suspension below the suspension line.

Example-21 The aerial firefighting system of Example-19, wherein the positive displacement apparatus includes a gear pump.

Example-22 The aerial firefighting system of Example-19, wherein the positive displacement apparatus includes an hydraulic cylinder.

Example-23 The aerial firefighting system of Example-19, wherein the positive displacement apparatus includes an electric linear actuator coupled to an hydraulic cylinder.

Example-24 The aerial firefighting system of Example-19, wherein the positive displacement apparatus includes a positive displacement flow meter.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. An aerial firefighting method for using an aircraft to controllably release a liquid from a resiliently collapsible sack hanging from the aircraft, wherein the resiliently collapsible sack includes a valve that is operated by an hydraulic valve actuator, the aerial firefighting method, comprising:
installing a positive displacement apparatus on the aircraft such that the positive displacement apparatus is higher and spaced apart from the hydraulic valve actuator;
opening the valve a certain amount by sending a drive signal that causes the positive displacement apparatus to force a finite volume of an hydraulic fluid between the positive displacement apparatus and the hydraulic valve actuator;
determining the finite volume based at least partially on a known volumetric displacement characteristic of the positive displacement apparatus; and
inferring how far the valve is open based at least partially on the finite volume.

2. The aerial firefighting method of claim 1, further comprising:
determining how much of the liquid is in the resiliently collapsible sack; and
progressively opening the valve to progressively decrease a flow resistance of the valve based at least partially on how much of the liquid is in the resiliently collapsible sack.

3. The aerial firefighting method of claim 1, further comprising maintaining the positive displacement apparatus and the hydraulic valve actuator in electric signal isolation from each other.

4. The aerial firefighting method of claim 1, wherein the positive displacement apparatus includes a gear pump.

5. The aerial firefighting method of claim 1, wherein the positive displacement apparatus includes an hydraulic cylinder.

6. The aerial firefighting method of claim 1, wherein the positive displacement apparatus includes an electric linear actuator coupled to an hydraulic cylinder.

7. The aerial firefighting method of claim 1, wherein the positive displacement apparatus includes a positive displacement flow meter.

8. The aerial firefighting method of claim 1, wherein the resiliently collapsible sack is a bag hanging by a suspension line from the aircraft.

9. An aerial firefighting system for an aircraft used by a user to controllably release a liquid onto an area over which the aircraft is flying, the aerial firefighting system, comprising:
a resiliently collapsible sack for carrying the liquid while the resiliently collapsible sack is hanging underneath the aircraft;
a valve frame attached to a lower end of the resiliently collapsible sack, the valve frame having a valve seat;
a movable valve member being movable relative to the valve seat to a desired valve position of a plurality of valve positions, wherein the plurality of valve positions covers a range extending from a fully closed position and a fully open position, the liquid being able to drain past the valve seat when the movable valve member deviates from the fully closed position;
an hydraulic valve actuator to move the movable valve member to the plurality of valve positions, the hydraulic valve actuator being supported by the valve frame;
a positive displacement apparatus attached to the aircraft and being spaced apart and elevated above the hydraulic valve actuator;
an hydraulic line connecting the positive displacement apparatus in fluid communication with the hydraulic valve actuator;
a finite amount of hydraulic fluid passing through the hydraulic line to force the hydraulic valve actuator to move the movable valve member a finite distance based on the finite amount of hydraulic fluid, the finite amount of hydraulic fluid being at least partially determined by the positive displacement apparatus;
a controller connected in signal communication with the positive displacement apparatus, the controller providing a drive signal to the positive displacement apparatus in response to receiving an input signal from the user, the drive signal commanding the positive displacement apparatus to move the finite amount of hydraulic fluid through the hydraulic line so as to force the hydraulic valve actuator to move the movable valve member the finite distance;
a communication signal transmitted between the controller and the positive displacement apparatus, the communication signal including at least one of the drive signal from the controller and a feedback signal from the positive displacement apparatus; and
a valve position value indicating that the movable valve member is at the desired valve position, the valve position value being provided by at least one of the feedback signal from the positive displacement apparatus to the controller and the drive signal from the controller to the positive displacement apparatus.

10. The aerial firefighting system of claim 9, wherein the controller and the positive displacement apparatus are in electric signal isolation from the hydraulic valve actuator and everything else hanging in suspension below the suspension line.

11. The aerial firefighting system of claim 9, wherein the positive displacement apparatus includes a gear pump.

12. The aerial firefighting system of claim 9, wherein the positive displacement apparatus includes an hydraulic cylinder.

13. The aerial firefighting system of claim 9, wherein the positive displacement apparatus includes an electric linear actuator coupled to an hydraulic cylinder.

14. The aerial firefighting system of claim 9, wherein the positive displacement apparatus includes a positive displacement flow meter.

15. An aerial firefighting system for an aircraft used by a user to controllably release a liquid onto an area over which the aircraft is flying, the aerial firefighting system, comprising:
a resiliently collapsible sack for carrying the liquid, the resiliently collapsible sack having an upper end and a lower end, the resiliently collapsible sack having a brim defining an opening at the upper end to receive the liquid;
a valve frame attached to the lower end of the resiliently collapsible sack, the valve frame having a valve seat;
a movable valve member being movable relative to the valve seat to a desired valve position of a plurality of valve positions, wherein the plurality of valve positions covers a range extending from a fully closed position and a fully open position, the liquid being able to drain past the valve seat when the movable valve member deviates from the fully closed position;
an hydraulic valve actuator to move the movable valve member to the plurality of valve positions, the hydraulic valve actuator being supported by the valve frame;
a suspension line to suspend the resiliently collapsible sack, the hydraulic valve actuator, the valve frame, the valve seat, and the movable valve member from the aircraft, the suspension line being coupled to the brim of the resiliently collapsible sack;
a load cell operatively coupled to the suspension line to provide a load signal that varies based on the weight of the liquid in the resiliently collapsible sack;
a positive displacement apparatus attached to the aircraft and being spaced apart and elevated above the resiliently collapsible sack when the resiliently collapsible sack is suspended from the aircraft by the suspension line;
an hydraulic line connecting the positive displacement apparatus in fluid communication with the hydraulic valve actuator;
a finite amount of hydraulic fluid passing through the hydraulic line to force the hydraulic valve actuator to move the movable valve member a finite distance based on the finite amount of hydraulic fluid, the finite amount of hydraulic fluid being at least partially determined by the positive displacement apparatus;
a controller connected in signal communication with the positive displacement apparatus, the controller providing a drive signal to the positive displacement apparatus in response to receiving an input signal from the user and the load signal from the load cell, the drive signal commanding the positive displacement apparatus to move the finite amount of hydraulic fluid through the hydraulic line so as to force the hydraulic valve actuator to move the movable valve member the finite distance;
a communication signal transmitted between the controller and the positive displacement apparatus, the communication signal including at least one of the drive signal from the controller and a feedback signal from the positive displacement apparatus; and
a valve position value corresponding to the finite amount of hydraulic fluid, the valve position value being referenced by the controller to help determine whether the movable valve member is at the desired valve position, the valve position value being provided by at least one of the feedback signal from the positive displacement apparatus to the controller and the drive signal from the controller to the positive displacement apparatus.

16. The aerial firefighting system of claim 15, wherein the controller and the positive displacement apparatus are in electric signal isolation from the hydraulic valve actuator and everything else hanging in suspension below the suspension line.

17. The aerial firefighting system of claim 15, wherein the positive displacement apparatus includes a gear pump.

18. The aerial firefighting system of claim 15, wherein the positive displacement apparatus includes an hydraulic cylinder.

19. The aerial firefighting system of claim 15, wherein the positive displacement apparatus includes an electric linear actuator coupled to an hydraulic cylinder.

20. The aerial firefighting system of claim 15, wherein the positive displacement apparatus includes a positive displacement flow meter.
